(19) United States
(12) Patent Application Publication
(10) Pub. No.: US 2002/0107767 A1
(43) Pub. Date: Aug. 8, 2002

(54) National branch network facility and system

(76) Inventors: Kevin J. McClair, Ridgewood, NJ (US); Les Dinkin, Westport, CT (US)

Correspondence Address: ABELMAN, FRAYNE & SCHWAB, 150 East 42nd Street, New York, NY, 10017-5612, US

(21) Appl. No.: 09/777,255

(22) Filed: Feb. 5, 2001

(51) Int. Cl. G06F 17/60

(52) U.S. Cl. 705/35; 705/42

(57) ABSTRACT

A national branch network facility for providing financial transaction-conducting capability as well as financial products sales capability and financial services; and non-financial products sales and services activity capability to businesses and affluent individuals who are customers of member institutions of the network, which is owned, operated, managed, and/or maintained by a third-party, as well as a network of such facilities is disclosed, together with a method of operation thereof.

### FIELD OF THE INVENTION

This invention relates principally to the field of physical structures and facilities, and networks of such structures and facilities, at which a plurality of activities including banking and other financial transactions and non-financial sales and service operations and activities occur and are conducted between the providers of banking, other financial and non-financial products and services and their clients and customers, particularly business clients and customers, and also selectively including those affluent individual clients and customers having a net financial worth, or other specified measure of value, in excess of a predetermined amount. The invention also relates to a method for providing a physical structure and facilities, and networks of such structures and facilities, at which a plurality of institutions, organizations, and businesses, which are members of and participants in a networked system owned, operated, and/or managed by a third-party, share space at structures and facilities that are part of the networked system by utilizing both certain common areas of a structure or facility and certain other portions or areas of a structure or facility that are individually designated for use by each respective participating member, or guest, institution, organization, or business, to offer their products and/or services to their clients and customers. Additional structures and facilities that are not shared, but are owned and/or operated individually by participating members of the network can also be integrated into the network.

### BACKGROUND OF THE INVENTION

Heretofore, the concept of a host business entity renting or leasing shared space to a number of guest business tenants has been practiced frequently in the context of retail merchandising of non-financial goods to individual customers. The most common example of such a situation has typically occurred with retail department stores, which often sublet retail selling space on the selling floors in their premises, usually as product display counter and shelf space, directly to certain manufacturers. This occurs most frequently in the cosmetics and apparel lines. It is not uncommon, therefore, in a local, regional, or national department store or chain, to find that the entire cosmetics department consists of a number of counters that are leased on a long term basis to major national and worldwide cosmetic manufacturers. In these situations, the floor space and the associated retail sales equipment, including such items as product display and storage counters, shelves, and/or racks, and even the “cash” or sales registers for “ringing-up” transactions paid for by cash, check, credit cards or debit cards, is typically owned by or leased from another party by the owner/operator of the department store rather than by the individual lessee tenants.

Thus, for example, in a Macy's department store, cosmetic manufacturers such as Revlon, Clairol, Max Factor, and Estee Lauder may all lease a separate counter of their own from which to display and sell their own product lines, where the retail sales staff for their respective counters are employees of the lessee, who are trained, provided, and paid directly by the lessee. In these situations, even the sales registers for any given counter are usually dedicated to sales of that one manufacturer's products sold from that counter, even though the transaction is conducted on a “for cash” basis or involves the use of a national credit or debit card or even a credit or debit card issued to the individual customers by the host department store lessor. Customers wishing to purchase products from several manufacturers need to engage in multiple transactions as they go from counter to counter to separately purchase each manufacturer's products. Separate sales and purchase transactions involving a single manufacturer's goods and products can more easily be tracked and the volume thereof on a given, e.g., annual, basis, can easily be determined and can be taken into consideration by the department store lessor in determining the cost of the lease to tenants on an individual basis when their time to renew the lease comes around.

Occasionally, a similar situation may exist in the apparel line, where various clothing manufacturers may lease space in the department store over a long period of time to set up their own fashion boutiques. Sometimes, as in the cosmetics area, the sales staff for these boutiques may be employees of the lessee, or, as is sometimes the case in the apparel area, although the retail counter display and selling space is leased by the manufacturer, the sales staff for these boutiques are employees of the department store lessor. For example, although designer name clothing manufacturers such as Calvin Klein, Tommy Hilfiger, and the like, as well as the myriad of women's apparel manufacturers may lease space in Macy's or J.C. Penny's department stores on a long term basis, the sales in these areas are conducted by individuals who are employees of the department stores, and not the manufacturers themselves. The transactions may be consummated either from individual registers in the various boutiques or manufacturer-leased sections of the store or centralized register stations, neither of which are specifically and solely dedicated to transactions involving a single manufacturer's goods, thereby enabling individual customers to select a plurality of items to purchase from various manufacturers and then pay for all at once.

In another retail sales situation, an owner of a premises that it wishes to utilize for retail merchandise sales purposes, ranging in size from an individual building to an entire mall, may rent or lease space to a number of retail merchandise-selling entities, while such owner retains ownership and control over the premises and is responsible for its maintenance and upkeep. Such arrangements are not even limited to buildings or structures and can even include the rental or leasing of space on open space, such as a lot or field, which is subdivided, with the resulting spaces being rented or leased on an event or “per-use” basis, from a single event or occasion to a periodic ongoing event basis, such as weekly, on weekends, or even daily, as may be the case for a “flea-market” type situation, wherein the individual retail sales entities can range from individuals to small business entities that may change from event to event due to high turnover; to an established shopping center or mall with a fairly permanent mix of large and small business entity establishment tenants. In the context of the foregoing “flea-market” and shopping mall scenarios, the premises typically contain certain common areas, such as walkways, elevators and escalators, restrooms, mini-park or rest area islands, food courts (excluding the food vendors, which are generally tenants themselves), and the like. These common spaces are under the ownership and/or control of the owner/manager of the premises, which is responsible for their upkeep and maintenance, and although such common spaces are not leased to any particular tenant, the use of such areas by the collective body of individual customers of the mall or flea-market's tenants inures to the benefit of all of the various tenants by providing various amenities for customers that the individual tenants would otherwise have to provide.

In the shopping mall scenario, the lessee tenant business entities typically rent or lease the space for their individual premises over a period of time of from one to several years, or even as long as from ten to twenty years in some cases, usually for the major of “flagship” stores at a particular shopping center.

In a “flea-market” scenario, it may also occur that the physical premises is owned by one entity, other than any of the sellers who agree to exhibit, and the event, either one-time or periodically regularly occurring, is arranged and managed by third-party arranger/promoter/manager.

In yet other situations, which heretofore have been limited to arrangements with non-financial, retail product selling entities, various retail sales property-owning entities, which do not, per se, sell any goods or products themselves, but merely own, operate, and manage the facility, such as Headquarters USA, rent or lease out space in their premises to various companies, firms, and business entities of various non-financial types, including retailers of non-financial goods and services. Some typical service-oriented businesses that may avail themselves of such an arrangement have traditionally been in the personal and pet care and grooming fields, such as barbers, beauty salons, and pet-grooming salons, photographers, photo-development businesses, pharmacies, and the like. In these situations, the tenants or lessees do not actually share any of the space with other tenants.

In the financial services sector, some “shared” space arrangements have previously been entered into on a very limited and infrequent basis by organizations and entities that service individual, non-business customers and clients, often where such individuals have some common characteristic, such as being employees of the same company or governmental body or members of the same service, political, or social organization, the most common of such financial institutions being a credit union, in what is usually referred to as a “business-to-consumer/customer/client” relationship, often represented by the acronym “B2C”, in contrast to a financial or business entity that typically deals frequently, predominantly, or exclusively with other business entities in a “business-to-business” relationship, often represented by the acronym “B2B”, wherein the providers generally are independent and the customers they serve are also business entities that do not necessarily share a required common characteristic, such as group membership.

For example, in a relatively small number of instances, in California and in Texas, two employee credit unions (CU's) agreed to share space in several new branches that they agreed to open together. In Orange County, Calif., the CU for county employees established an arrangement with 100 other credit union branches, whereby customers of one CU can conduct many activities and transactions, such as making deposits and withdrawals, and applying for loans, with the county employees' CU while they are at other CU locations. 25 Although this “shared transaction” capability offers an accommodation benefit to customers who are traveling in an area outside their ‘home area’, any one such location does not house representatives from all of the participating institutions so as to enable each and every one to provide face-to-face sales & service capabilities.

Furthermore, a limitation on this type of arrangement is that customers of one of the member credit union institutions participating in such an arrangement can rarely, if ever, simultaneously be a customer of another such participating entity, because a customer must generally be a member of the group around which a particular credit union is organized, and most individuals usually qualify to join only a single such credit union. Such an arrangement, therefore, offers the participating member organizations little, if any, opportunity of acquiring new cross-over customers as a result of its participation in such an arrangement. In a situation, such as is provided for by the present invention, where there is a variety of different types of both financial and non-financial institutions present at a site, there is a far greater opportunity for an economic multiplier effect where customers can be patrons of more than one of the participating member entities at the site.

In the B2C financial services area, PNC Financial and at least one other bank have entered into arrangements to share space with certain CU's. These arrangements are made to accommodate and provide financial services to a low to moderate-income clientele in their local area.

Also in the B2C financial services area, it is well established that individual banks have opened “supermarket” branches located on-site at larger grocery shopping stores and supermarkets of major regional and national chains, having high sales volumes and large numbers of customers, principally as a convenience to the financial institutions' customers.

These “supermarket” branches are generally small and may have, at most, only one or two tellers or other bank employees on site, and sometimes none, frequently relying extensively or even exclusively on automation to provide limited services via ATM's, for example. More recently these “supermarket” branches have also appeared at other locations such as smaller to medium-sized shopping malls and even on-site at major corporate sites to service the employees who are bank customers. One characteristic of all such branch sites, however, is that they represent only a single bank or financial institution, not multiple ones. This is a severe disadvantage for individuals who are not customers of that institution.

For customers, it would be advantageous for such single institution sites to instead have multiple financial institutions so as to give customers a greater choice than simply place them in a situation where they can either only become a captive customer of the institution represented at the site or forego the ability to be afforded any services there at all. It could also be advantageous for the site owner to elect to allow more than one institution to be represented there, or for the institution with a presence at the site to enter into an arrangement with other financial institutions to allow the customers of such other financial institutions to also use the facilities, for which, in return, the customers and/or the other financial institutions would pay a fee or some other compensation.

Certain non-financial, substantially service-providing companies, such as Mail Boxes Etc.® (MBE) have recently begun to “take deposits” at their locations. To-date, this capability has been limited to only this deposit-taking function, with no known evidence of plans to provide face-to-face, either human or virtual, sales and service capabilities, a feature provided for in certain embodiments of the present invention.

In Pennsylvania, several years ago, at least two banks established a “swapped deposit” capability, whereby customers of the two banks were allowed to use the teller services at one another's branches. The banks may have been owned by the same parent holding organization, or the arrangement may have been a temporary one, such as just prior to a merger or acquisition between the two banks. In any event, that arrangement was not the same as the branch network system of the present invention in several ways, including that a complete network of institutions, including both financial and/or non-financial, was not established; there was no transaction processing capability servicing multiple institutions operated and managed by a third-party other than one of the banks or other member institutions; and a multi-bank shared sales and service capability for other financial products and services apparently was not offered.

Heretofore, banks, particularly commercial banks, as well as other financial and financial-related product and service providers, such as investment banking houses, business mortgage brokers and lenders, stock brokerage and investment houses, and venture capital lending institutions and groups; as well as non-financial organizations and institutions that provide business-to-business products and services of a non-directly financial or quasi-financial nature, such as insurance companies; and other businesses and institutions that provide yet other non-financial, commercial and business-related products and services, chiefly to other businesses; such as temporary, part-time and permanent personnel agencies and services, particularly in the clerical and secretarial areas, but also including various professional and para-professional jobs and occupations, such as bank tellers, bookkeepers, accountants, engineers, computer and information technology (IT) professionals, and attorneys; out-sourced business services providers in areas such as accounting and payroll services; law offices; and other business materials and service suppliers, including office supplies vendors; copying and duplicating services; messenger and courier services; travel agencies and travel service arrangers and providers; computer hardware and software leasing, sales, support, and maintenance and repair service stores and providers; telephone and wireless products and services stores and providers; mobile telephone services, and the like; as well as public, private and/or governmental agencies, organizations and institutions, especially those in business-related areas, such as certain commercial dispute arbitration boards and agencies, the Internal Revenue Service (IRS), the Department of Labor; as well as any of the foregoing that also occasionally and selectively provide their products and services to certain select individual preferred clients and customers, such as typically only the more affluent individuals, who are identified and selected on the basis of their net financial worth or other pre-established criteria, and who generally have a net worth in excess of some predetermined thresholds established by the various organizations and institutions, and who maintain personal, non-business accounts, have typically maintained separate, distinct, dedicated, and uniquely branded physical structures and facilities, ranging from an entire building to a floor of a building to a single office in a large number of locations, most locations usually being in or near to the principal business districts of most major cities. Such organizations have heretofore not shared space in any building or facility, except on a very limited basis, and usually by only two entities. Moreover, in many large cities in the United States, such as New York, Chicago, Dallas, and Los Angeles, individual organizations and institutions are often required to maintain multiple facilities in the same city, especially where there are several distinct commercial districts within a city and its environs. In the greater New York City metropolitan area alone, for example, many organizations and institutions maintain facilities in downtown Manhattan's Wall Street financial district, in the mid-town Manhattan business district, as well as in the nearby business districts of Newark, N.J., downtown Brooklyn, Nassau County on Long Island, Westchester County, and Stamford, Conn. Multiplied by hundreds of cities across the United States and worldwide, this entails a tremendous investment and often huge capital expense in the physical structures themselves, or, at least a high expense for leases and rents, in those instances where the properties are not owned outright. Notwithstanding the tremendous increase in the number of services made available over the Internet, and the corresponding use of such services by business and affluent individual customers, there is a large number of such business and individual clients and customers who prefer to have a definite physical, “bricks and mortar” place, location, or structure to which they can go to engage in certain transactions with individuals representing the institution, either in-person or virtually. In many instances, the clients/customers of these institutions, organizations and other business entities eschew the Internet and other technology and telecommunications based methods of remotely performing transactions because they distrust the security and confidentiality aspects and provisions of the Internet and other forms of electronic commerce and, at least on some occasions, much prefer to deal, in real time, face-to-face with a live or virtual individual who is a representative of the institution, organization, or business with which they wish to do business, on a real-time, immediate, one-to-one basis, rather than conduct their transactions and other activities with a “faceless” machine, such as an ATM, or at a much slower pace by mail.

Accordingly, there is a need, principally in the business-to-business world, but also extending to and including the circles of affluent individuals, for a place or location with the requisite facilities and equipment whereby various financial and non-financial institutions, organizations, and businesses can provide their respective products and/or services to such clients and customers, on a real-time, face-to-face live or virtual basis, and on a local, regional, national, and/or global scale, without each and every such institution, organization, and/or business having to incur high initial capital investments in buildings and facilities, high ongoing maintenance costs, and/or high lease or rental fees and payments to provide and maintain dedicated facilities at a plurality of places and locations for use by their clients and customers. There is a potential savings in the hundreds of thousands to millions of dollars to these various financial, non-financial, and business/commercial providers and their customers in being able to provide the facilities needed to much better accommodate their clients' and customers' business, and in the case of the affluent, also personal, financial, non-financial, and related commercial/business needs, while not incurring high costs for construction, maintenance, and/or leases and rents for structures and facilities exclusively owned by and/or operated by one institution, organization, or entity. There is also a significant revenue potential available to “Internet-only” institutions to utilize the services of a national branch network system in order to bring their products and services to markets with customers and clients who require a level of face-to-face contact, which they otherwise might not have effectively served or entered at all.

### SUMMARY OF THE INVENTION

Accordingly, it is one object of the present invention to provide a facility or place, as well as a network of such facilities or places, as a National Branch Network (NBN), where a plurality of product and service providers, including at least one financial product and service provider, and up to a number of other providers of products and services of a financial, non-financial, and/or commercial/business nature are located at the facility to provide their products and/or services to their clients and customers, and where the plurality of institutions, organizations, businesses, and/or entities that are the product and service providers share the use of certain common portions of the facility and have certain other portions of the facility designated for the exclusive use of each, respectively. Collectively, a number of locations or places, each of which individually can be all or part of a specific structure, that is a facility where a plurality of institutions, organizations, businesses, or entities share at least a part of the total space and certain of the functions and activities associated with the facility are performed for at least some or all of the member tenant institutions by a third-party facility owner/operator/and/or manager, and where the individual member tenant entities also maintain an activity-conducting capability according to the present invention, constitutes a national branch network (NBN) of the present invention.

It is a further object of the present invention to provide a facility wherein providers of products and services that maintain a presence at the facility can afford their clients and customers access to everything from a selected range to a full range of the providers' products and services, utilizing person-to-person human interface activities, human governed electronically assisted activities, exclusively electronically handled activities, and combinations thereof for any and all of the services rendered at a particular facility by any specific provider. Providers of products and/or services that maintain a physical or virtual presence at a facility will hereafter also be referred to as “guests” of the facility.

It is a further object of the present invention to provide facilities at a plurality of locations or places that are networked together, wherein each facility may occupy all or a portion of a physical structure, such that management and operation of the overall facility at every location or place is conducted by a party, which may itself be one of the member institutions and providers of products and/or services that maintain a physical and/or virtual presence at the facility for conducting any of financial transactions and/or other financial and/or non-financial sales and/or service activities, or which may be a third-party that is not itself one of the member institutions. The NBN “managing” party may also be an actual owner or a lessee of the physical space of the facilities. It operates and manages each facility with personnel who are its employees and/or agents, who are located physically and/or virtually at each facility or at certain selected facilities in the network, and/or are at least physically located at a central location from which one or more or all the facilities in the network are managed. The managing and/or owning entity of each of the facilities of the network is hereinafter also be referred to as the “host” or manager of the NBN and its component facilities or branches.

It is a still further object of the present invention to provide a NBN wherein the physical structure or facility that is the NBN is constructed or configured differently to meet the specific combination of institutions, organizations, and/or entities that are resident at any particular site.

It is yet a still further object of the present invention to provide a further consumer choice option to businesses and affluent individual customers from which they may select for the provision of such financial and non-financial services and products.

As used herein, the term “operations” is used to refer generally and collectively to both the actions and activities of both a financial and/or a non-financial nature, conducted between the financial institution members or “guests”, or other non-member “guests”, of the NBN and their clients and customers, and such that financial actions and activities are specifically referred to as “transactions”; and to the actions and activities of a financial and/or non-financial nature, conducted between the non-financial institution members or “guests”, or other non-member “guests”, of the NBN and their clients and customers, which non-financial actions and activities are specifically referred to as sales and service. Operations include all forms of both the financial and non-financial actions and activities, transactions, sales and service, and communications performed at NBN branch facilities by the NBN members with and for their customers, including those of a “face-to-face” nature as well as those of a virtual and/or other electronic nature, as well as all of the aforementioned as performed by NBN branch members between and among several NBN branch facilities and/or with a member institution's central office or headquarters or other satellite offices or locations.

As used herein, the terms transaction or financial transaction are used to refer to substantially “cashless” financial actions and activities involving the transfer of monetary assets on a non-cash basis between NBN members and their customers, except that at those NBN branches where cash transactions, either through teller facilities and/or ATM's are authorized and are permitted by law, the acceptance of cash deposits and the dispensing of cash are also considered financial transactions.

Other actions and activities, of a substantially non-financial nature, that is, not involving the transfer of monetary assets per se, and involving the provision of services of an advisory or consulting nature, or the sale of goods, are referred to herein as non-financial activities or sales and services.

As used herein, the terms “member firm(s)”, and simply “members” are used interchangeably, unless otherwise noted, to generally designate all “guest” financial and non-financial services and products providers that maintain a physical and/or virtual presence at one or more NBN branch facility, including institutions, organizations, businesses, and other entities.

An NBN according to the present invention is a network of shared physical locations which offers banks, insurance companies, retail brokerages, and other service firms a national branch network in which to sell and/or service their products and services to business owners and other selected affluent individual customers. The NBN also offers both Internet-only operators, as well as brick-and-mortar companies, a cost-effective branch system by utilizing shared space for transaction and/or sales/service functions. Finally, the NBN offers small businesses and affluent consumers more choices of whom to deal with for the provision of these products and services. One function of the NBN is to act as a small business customer's advocate for cost-effectively bringing them in-person and/or virtual, real-time, top-quality financial and non-financial resources to help their business be successful.

For the United States, on an overall nationwide basis, we have determined that a network of approximately 150-200 NBN “branches” is likely sufficient to service a majority of small businesses and their owners, as well as other individual person clientele, based on a predetermined level of financial net worth. An important feature of a NBN system according to the present invention is its flexibility and adaptability. A network can be set up with only several branch office facilities, with as few as from about 4 to about 12 branches servicing a local metropolitan area (SMSA) or region; or from about 30 to 60 branches, initially, for a US nationwide system. The network can subsequently easily be expanded to other regions and/or additional branches can be added within a local area or region as needed. A majority of NBN branches would be located in those major cities with financial and business centers.

The nationwide branches of the NBN system can be flexibly tailored and constructed according to a number of various formats described in greater detail below. The particular format for any given branch location is determined from a consideration of such factors as the number and size of the business and individual clients to be serviced; and local and regional styles, trends, customs and preferred practices for financial and non-financial transactions. Some of the types of individual NBN branch locations that form part of the present invention and which can be incorporated in a nationwide or worldwide system for multiple NBN clients include:

full-service branch locations, at which both financial and non-financial member institutions or firms are present, at which financial and non-financial sales and service are provided, in addition to financial transaction capabilities, and wherein the participating financial and non-financial members utilize the facility on a physical and/or virtual shared-space basis;

transaction-only branch locations, at which there are only financial transaction processing capabilities, which are performed by NBN representatives; and

sales and/or service-only branch locations, at which financial member firms (but not having financial transaction capabilities) and/or non-financial member firms are physically and/or virtually present, at which substantially no financial transaction processing capabilities are provided (except perhaps for the presence of an ATM), at which essentially only non-financial sales and/or service capabilities are present, and wherein the participating members utilize the facility on a physically or virtually shared-space basis.

One of the many novel and important aspects of the NBN of the present invention is that both the individual branch units and components of the overall system, and thus the overall system as well, has great structural variability and variety, enabling the easy adaptation of the system to local conditions and demands.

Accordingly, for example, the component branch elements of the system are capable of being designed and constructed to provide a variety of on-site, real-time, face-to-face physical and/or virtual sales and service activities that are delivered by employees or agents of various banks, and at the same time to also have the flexibility to also offer transaction processing and on-site sales and service activities by other financial and non-financial firms targeting the small business and high-end individual financial customer markets.

Any of these three types of branches, which constitute components or modules of an overall NBN system, can be stand-alone facilities, or alternatively, can be located within existing business space (e.g., at Office Max® stores, HQ Business Centers®, etc.). Within a network of many branch locations, there can be a mixture of different types of branches, in any combination. The unique aspect of this approach, in contrast to existing dedicated or single financial service provider “supermarket” type bank locations is that an NBN facility offers financial and/or non-financial services to clients of many different banks or institutions, not just one.

According to one method of operating the NBN system according to the present invention, the direct members of the NBN, which are financial and non-financial firms, enter into an agreement with NBN for space and operations capability for one or more of the various branch formats, at each location that the client wishes to establish a presence. Depending on size of surrounding market, the NBN administrator may offer various combinations of the above formats in order to optimally provide coverage for that given market. This flexibility of shared-delivery provides each member firm with a fast, more cost-effective way to gain the national branch presence necessary even in today's virtual world and to build their small business and/or affluent consumer franchises without having to buy other banks or build their own branches or other office facilities. Another advantage of the NBN system of the present invention to member institutions is that they can elect to participate in the NBN network only at sites in locations that are appropriate for them. Certain institutions may do business, or, in the case of financial institutions, be chartered or licensed by state agencies, such as state banking authorities, to operate only in a specified geographical area. Such institutions may elect to establish a presence at NBN branch facilities within their appropriate sphere of operations. Other institutions that are not geographically restricted as to their areas of operations may seek to expand into new territories by establishing a presence at one or more NBN branch facilities in new marketplaces for them. Participation in an NBN also affords members, both in the context of new member institutions as well as existing members expanding into new territories, an easy and relatively low-cost opportunity to test the marketplace in order to ascertain whether they will attain sufficient business volume in that area so as to warrant eventual expansion into their own dedicated place of business, without having to make large capital expenditures in advance.

### BRIEF DESCRIPTION OF THE DRAWING

FIG. 1 is a plan view of a typical NBN branch office facility according to the present invention.

### DETAILED DESCRIPTION OF PREFERRED EMBODIMENTS OF THE INVENTION

Unless otherwise noted, as used hereinafter, the terms “NBN branch customer(s)”, “branch customers”, and/or simply “customer(s)” are used interchangeably and refer to users of the NBN and its facilities, who are both business owners (BO's), including both individual persons who are the owners and/or officers, managers, or key staff of small, medium, and large business entities, which may be sole proprietorships, partnerships, and/or corporations, and/or any other form of organized business entity legally recognized in the jurisdiction where an NBN facility maintains a presence, and the legal agents and/or designated representatives of any such entities; as well as certain affluent individuals (Al's), who are not business entities, having a financial net worth or other measure of value, at or in excess of a threshold level predetermined by the NBN or its members, either on an absolute system-wide basis or on a relative basis for a particular given geographic area where an NBN facility maintains a presence, with such individuals acting on their own behalf, and/or through designated agents and/or representatives.

A schematic of one type of a representative branch facility of an NBN system is shown and the method of its operation is next described. Other variations and permutations of this facility, with different capabilities are discussed later.

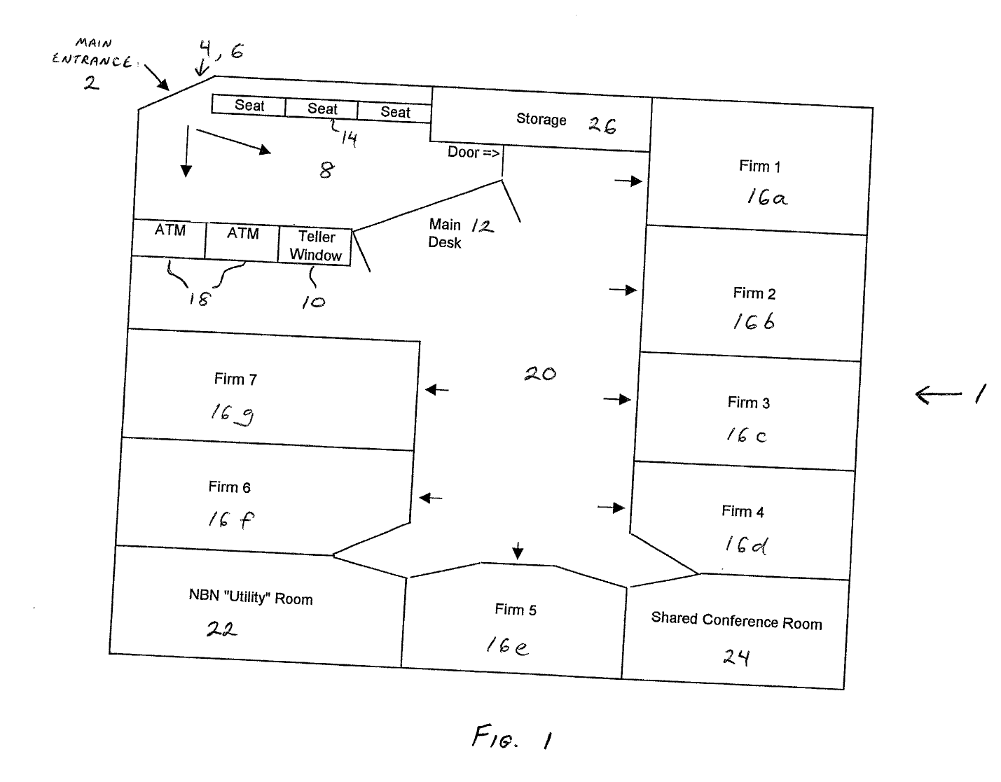

Referring now generally to FIG. 1, NBN customers enter the NBN branch office or facility 1, through a main entrance 2. NBN signage 4 indicating the nature and purpose of the space is posted. Depending on the location of the branch office, namely, whether it is situated on a ground floor of a building or on an upper floor of a high-rise office building, NBN signage and/or a directory listing as an NBN facility may be displayed on the ground floor and/or on a ground floor building directory, and/or in a common area (e.g., hallway after exiting an elevator) in a large multi-story building. A branch location may optionally have external signage and/or a directory 6 indicating the identity of each of the NBN member firms operating at that location. Such individual member directory listings may be posted after the NBN's own operating name on a general building directory in a lobby of a larger, multi-story building, and/or on a separate directory just outside the NBN office on its own floor of a multi-story building. Other than allowing an NBN member firm to list its name on a directory of member institutions present at the NBN branch site, however, no firm-specific advertising, signage, other promotional material, or merchandising activity is permitted anywhere within the NBN branch facility except within the member firm's assigned office space.

A customer of the NBN branch first enters a general reception area 8. This area generally includes at least one and/or several and/or all of: a transaction processing capability area 10, a main desk 12, and a waiting area with seats 14. The main desk 12 is where a customer checks-in for, or to schedule an appointment to see the representative of the member firm with which the customer desires to do business. Customers must schedule appointments to see representatives of the member firm(s) that they desire to see. Appointments can be made in advance by phone or on an “as-available” basis by walk-ins. In any case, customers may not simply proceed directly to any of the individual member firm spaces unannounced. The main desk 12 is staffed by an NBN employee, who manages the appointment queuing to each of the member firms 16 a-g, answers the main NBN branch facility phone, monitors general branch security, and performs other general branch related, non-firm specific duties and tasks. If a particular branch does not have a teller station/window 10 at the facility, deposits of a non-cash nature only can be made and are handled at the main desk 12 in the same manner as if they had been made at a teller-operated window. Seating 14 is provided in the general reception area for branch customers while they wait to see their representative. Each branch may include a teller function 10, which functions essentially the same as a bank teller window, but which may or may not be similar to a bank teller window in its physical appearance, at which customers can make check and credit card deposits. Optionally, cash may be accepted and/or distributed at this teller function location/window, depending on the specific contractual agreement between the NBN operator and the member firms, as well as on applicable national/federal and/or state banking laws. The NBN operator may seek formal bank branch status in one or more of the states or other geo-political regions in which it operates.

Where an NBN branch accepts a deposit as a bank branch, the deposit is accepted and the deposit ticket is endorsed appropriately. Where an NBN branch accepts a deposit as a non-bank branch, an advice slip acknowledging that the deposit was dropped-off is handed to the customer. Also, entry of the deposit into a deposit terminal is then made. This permits the NBN to electronically send to each member firm a listing of all its customers who made deposits to their firm and the dollar value of such deposits. Such information can be transmitted by the individual NBN branches themselves, or it can be transmitted from a central NBN office which collects the information from the individual branches of the system, and in turn sends it to the member firms. Such information can be transmitted on either an instantaneous basis, or on a periodic basis, such as once or twice a day. A member firm, in turn, has the option to give either an immediate or a time-delayed credit to its depositing customers for those funds, before the firm has actually received the physical deposit from its customer.

An NBN branch may also optionally feature one or more automated teller machines (ATM) 18 at a branch site, as well as other electronic sales and service or information devices, which may be located in one or more sub-divided areas or in one or more separate kiosks. Where the decision is made that cash will be disbursed at a particular NBN branch office facility, unless there is a human-attended teller function at the site, ATM's are the only way cash can be disbursed to customers, who make withdrawals from their accounts using the ATM's. Other ATM functions, such as the giving of account balance information, accepting check deposits, etc. can also be performed. Alternatively, the ATM's are serviced and maintained either by NBN employees/contractors or by an outside third party with no NBN involvement.

Another feature that certain embodiments of NBN branches may offer as an alternative to providing an ATM at the site, is to provide a Quick Deposit Box function. A Quick Deposit Box is a secure box at which only non-cash deposits are accepted, and for which a time-stamped advice acknowledging receipt of the deposit is issued in return for accepting a deposit.

A yet still another feature that certain embodiments of NBN branches may offer is to provide information kiosks (not shown) at which customers can obtain information and/or literature relating to various ancillary business matters, including, but not limited to information on how to start a business; how to form a corporation; local, state and/or federal or other applicable jurisdiction laws and forms for starting a business. Any of the foregoing types of information can be provided either in hard-copy or electronic form. The information can be provided through any of the NBN host manager, and/or the NBN members. Separate information kiosks can be set up.

When a customer's appointment time with one of the NBN branch member institutions is reached, the customer is permitted to enter into the office area 20 behind the main desk, to access the office space 16 a-g for the member firm that the customer desires to visit.

Each member firm's office space 16 a-g generally contains at least some of the following items (not shown):

Desk(s), chairs, and/or conference table(s) for use by member firm employees and customers;

File cabinet(s) and/or other non-electronic data and information storage facilities, for storing files relating to customers, product information, etc.;

At least one dedicated phone line, answered by member firm staff and having a dedicated voice mail function with at least outgoing message capability and preferably also including incoming message receipt capability;

Member firm-specific merchandising, signage and/or other promotional advertising pertaining to the member firm and its products and services, as desired by a firm; and

A computer set-up, including a central processing unit (CPU) and peripherals (keyboard, monitor, printer) capable of two-way communication directly with the member firm's computer system, either by being hard-wired thereinto or capable of accessing the member firm's computer system by electronic communication lines such as telephone lines and/or an Internet connection;

Each NBN member's office space within an NBN branch facility is intended to be a stand-alone office whereby the firm's employees and representatives can perform all the activities that they would be called upon to do if they were in a ‘regular’, dedicated branch office of their firm. In addition to the main financial and/or non-financial activities that are characteristic of a particular member's regular line of business, certain other general sales and/or service activities can readily be performed from NBN offices. Some typical sales and service related functions, activities and tasks that would also be performed from an NBN all branch office facility include:

Telemarketing of new prospective customers;

Telemarketing existing customers about new products and services;

Periodically calling existing customers to review their status and needs;

Provide information to and answer questions of prospects and customers by phone and in-person.

Open new deposit/insurance/investment/brokerage/sales accounts/take loan applications for new customers, as applicable to the member firm's line of business;

Open new deposit/insurance/investment accounts/take loan applications for existing customers, as applicable to the member firm's line of business;

Start and/or solve the process to resolve customer service problems and complaints with accounts; orders, etc., as applicable to the member firm's line of business; and

Close accounts.

At certain NBN branch facilities, performance of certain of the above functions, although within a given member firm's ambit of activity, may, however, be excluded or prohibited due to the operation and provisions of law in the jurisdiction where the branch facility is located.

A “firm office” at an NBN branch site can be the office for one or more employees of the NBN member institution, who are assigned to that branch location, or, alternatively, it can be a “shared-office” used at different times by various employees or representatives of that firm who are assigned to that NBN office on a rotating or “job-share” basis. This feature permits the firm's representatives to maximize their time visiting, customers/prospects at their business locations.

According to the general embodiment of an NBN branch office facility according to the present invention, each NBN branch office also includes an NBN Utility Room 22, which serves several purposes, including:

A place at which deposits made by customers are readied for further processing, either by forwarding to the designated recipient member institution, or by forwarding to central bank facilities for processing, check clearing, etc.;

A break room for use by the NBN facility's staff, including both employees of the NBN and the member institutions as well; and

A place for extra storage of supplies for use by the NBN facility, both the NBN staff, and member institutions. Member institutions may keep their additional supplies for use by their own organization only, in secure, segregated areas within the Utility Room.

Additionally, a branch office may have one or more of: a shared conference room 24, the use of which can be scheduled by any of the member firms through the main desk; and an additional storage room, which can be subdivided to give each member firm a secure section in which to store additional supplies.

A still yet other specialized shared space that can be set up at an NBN branch office facility is a library/research center (not shown), wherein participating members and their customers can have access to business and financial publications, periodicals, and other information, such as over the Internet and by stock ticker.

The NBN branch office illustrated in FIG. 1 represents only one typical branch configuration set-up to accommodate a total of seven member firms, which can all be financial, non-financial, or a combination thereof. As will be appreciated, other branch office facilities within the scope of this invention, having different physical shapes and layouts within the general constraints and guidelines set forth above with regard to restricting and directing customer access to various parts of the facility through a main desk, and able to accommodate different numbers of member firms, either fewer or greater, can readily be set-up.

The deposit processing function done at an NBN facility can alternatively be accomplished in several ways. Some of these alternative methods include, but are not limited to:

Shipment-only, wherein NBN staff does not actually process the deposit, but merely packages it into an overnight envelope and ships it to the intended member institution recipient for next day processing. As a monitoring step and a security precaution, the NBN staff may microfiche/photocopy each deposit slip prior to shipment. Additionally, notification of the pending deposit or payment may be made to the recipient member firm utilizing a predetermined notification process, which preferably is electronic, and may include, for example, email, and online notification.

Actual-processing, wherein the NBN staff also processes the deposit using standard bank check-processing procedures. In this case, rather than the checks being packaged and shipped to the different member firms for which they are intended, the checks are processed and sent to the central check clearinghouse in that geographical area, for routine banking system processing.

Customers may use their respective firm's deposit tickets when making deposits. In this instance, the NBN stamps such deposit tickets with a special stamp, indicating that the deposit was received by the NBN and how it was processed (shipment or actual). Before customers are permitted to make deposits at the NBN facility, each member firm enters into one or more agreement(s) with NBN and/or where a member firm is not itself a financial institution, their own financial institution as well, as to determining the liability each party has, if any, in handling such deposits/receipts/shipments, and/or making payments or is disbursements.

The following describes some of the roles and responsibilities of the NBN organizer and the participating member institutions of the NBN.

The NBN system and its component branch office facilities are themselves owned and/or leased, organized, managed and staffed by a third-party entity that may or may not be one of the participating members.

Individual NBN branch office locations can be owned by the NBN organizer or obtained by the NBN organizer through long-term lease arrangements with another party that, generally, is also not one of the participating member institutions. In some instances, however, it may be possible that an institution which seeks to be a participating member of the NBN and which has a suitable building or parcel of property for use as an NBN branch office facility, may enter into a long term lease arrangement with the NBN organizer.

The member financial and non-financial institutions and firms are the direct clients of the NBN operating entity. Each such firm is responsible for at least all of the following functions and activities:

Securing its own permits/licenses for conducting business in the geographical jurisdiction (city, state, etc.) of each NBN branch facility at which it chooses to maintain a presence;

Hiring and compensating its own employees and/or any independent contractor representatives;

Selecting the décor for its own firm office space at each NBN branch location from several acceptable options provided by and/or approved by the NBN owner/operator;

Selecting the numbers and types of various electrical and electronic connections for telephones, computers, the Internet, and other devices and appliances, such as photocopiers and fax machines, from a list of acceptable choices provided by the NBN manager, to meet the individual member firm's needs for each branch facility;

Supplying its own merchandising and product materials to be used in its office; Entering, into a sublet agreement with NBN; and

Carrying its own insurance(s) (e.g., property damage, theft, and personal accident liability) for all operations it conducts at NBN branch facilities.

To facilitate work and to take advantage of purchasing economies, the NBN manager may make non-binding recommendations to its member firm clients as to providers of any of the above supplies, products, and services, which the member firms may wish to utilize.

Day-to-day operations of the NBN are governed by the NBN owning and/or managing entity. The NBN manager sets the operating times of the NBN branch facilities, which can vary geographically from region to region and even locally from one branch to another in a given region, depending upon such factors as local custom. Typically, an NBN branch facility follows a schedule wherein it is open six (6) days/week, at different times on different days of the week, such as, for example, Monday through Wednesday and Friday, from 9:00 AM to 5:00 PM, Thursday from 9:00 AM to 7:00 PM and Saturday from 9:00 AM to 12:00 PM). At the times during which the NBN branch facility is open for business, each member firm is able to operate its office, and its customers will have access thereto.

According to certain embodiments of the invention, provision can also be made for non-regular-customers of the NBN member firms (e.g., non-business entity, individual walk-in customers, who do not meet the threshold criteria for being accorded regular customer status) to use the ATM's at those NBN branch facilities that are so-equipped, with applicable usage fee charges, which may vary by location, being charged.

Generally, the opportunity to meet with a representative of one of the member firms is arranged by appointment only. If a non-regular-customer desires to obtain a list of firms conducting business at the facility, they are given a list that includes the names of all of the member firms maintaining a presence at that branch location, the general NBN phone number of the branch, and any member firm website addresses.

Each member firm is responsible for ensuring that their active NBN branch locations are entered into a listing or directory of their branches, and for communicating contact information to the NBN representative at each branch site.

Typically, each NBN branch facility will have about at least three permanent regular staff members, who are employees of the NBN owner or manager. These three individuals occupy positions as follows: one teller; one main desk receptionist/representative; and one supervisor. The supervisor serves as back-up for the other two NBN staff positions. The number of NBN staff member employees at any given branch facility may vary, however, depending on the specific location, size of the office and number of member firms located thereat, etc.

As will be understood by persons skilled in the art of providing financial and ancillary non-financial services to businesses and affluent individuals, an NBN branch facility according to the present invention can be flexibly configured to meet local conditions and demands.

The following discusses some of the factors that are generally considered in determining how a particular branch facility of an NBN should be optimally configured for a given location. It is to be understood that the various permutations of NBN branch facility configurations represent alternative embodiments within the scope of the present invention.

A first consideration is to determine the essential operating character or mission of a particular NBN branch facility, that is, what is the nature of the activities to be conducted at the site. The NBN organizer can plan, organize and configure any given NBN branch office or facility within the overall network such that any one or more of the following are provided at a particular NBN branch office or facility, either alone or in combination: financial activities, including substantially banking and bank-like monetary financial transactions involving cash and/or non-cash exchanges (e.g., receipt of cash and non-cash (i.e., checks) deposits and disbursements of cash and cash-equivalents (e.g., money orders), and not involving any other exchange of goods and/or services; financial sales and service activities of a non-exclusively monetary nature and involving the provision of goods and services deemed to be of an essentially financial, but not specifically purely “banking” or monetary nature, including, for example, mortgage application processing and related lending activities, personal (i.e., life) and property (i.e., casualty, fire and theft, etc.) insurance application processing; and stock brokerage activities; non-financial activities principally involving the exchange of goods and/or services, although payment therefor may be in cash or cash equivalents or on credit. Different NBN branch facilities within an overall networked system can be organized and configured according to any and all permutations of the foregoing missions or functional types.

After determining the essential operating character or mission of a branch office or facility, the next step the NBN organizer performs is to determine the optimum size for the specific location. This involves a number of factors related to both the number of participating member entities for the given site as well as the number of their customers. An estimate of the volume of physical traffic that an NBN branch office location will be expected to see, on average, on a daily basis can be made from readily available demographic and statistical information for the area in question.

For any tentatively proposed branch location, this involves a determination of the number of businesses that are located within a typical service radius that the branch is intended to accommodate, the customer bases of the participating institutions, as well as other factors. Depending on the geographical area, this may range from several blocks in a major business district of a large city to up to a hundred miles or more in a relatively lightly populated, decentralized rural area. Such a territory may, nevertheless, still have a large potential number of customers, albeit spread over a wide area, rather than concentrated in a smaller area, such as a business district. If the NBN branch facility will also service affluent individual customers in its service area, a determination of the number of such potential customers will also be made.

Some sources for demographic and statistical information pertaining to potential customers, both businesses and affluent individuals, of an NBN branch include chamber of commerce and local government surveys, as well as privately published information. Alternatively, the NBN organizer can first seek to solicit participating member institutions for a site and then rely on the institutions own customer information and volume estimates to arrive at an optimally sized facility. Where the NBN organizer has a reliable starting estimate of the customer traffic volume for a branch, it must then also ascertain what are the potential member entities that might desire to establish a presence at that particular NBN branch office, consistent with the established mission statement for that branch as being of an exclusively financial nature, exclusively non-financial nature, or a combination of financial and non-financial. Generally, most NBN branches within a network system containing a plurality of branches, will have a mixed capability and will host at least one bank or other financial institution and may host one or more non-financial institutions, although within an overall network of branches, especially those with a number of branches in a relatively limited geographic region, there may be certain situations where it is desirable that one or more branch sites within the network be dedicated solely to providing substantially only one type of capability, financial or non-financial, and a nearby branch be dedicated to providing the other type of capability. Thus, certain branches of a NBN system may be exclusively non-financial in nature, focusing on the provision of substantially non-financial sales and services, notwithstanding that certain transactions and activities that are within the scope of the sales and services rendered by such non-financial institution participating NBN members and rendered at that site may be of an essentially financial nature, e.g., cash and/or credit sales of goods and/or services.

In considering potential member institutions for any given branch site, the NBN organizer will also consider the potential for recruiting participating members for the NBN from amongst non-local or non-regional banks and other financial institutions that are licensed to operate in other territories, or which may desire to and be able to obtain a banking or other operating license, wherever required, in a new territory into which a bank may wish to expand and where an NBN branch is to be located. Information about local banks, especially commercial banks, and other financial institutions is readily obtainable from a variety of governmental and private sources, including state banking authorities and local and regional chambers of commerce. Where appropriate for the particular branch location, the NBN organizer then determines what other non-financial institutions and entities it desires to have as guests maintaining a presence at an NBN branch site. The types of non-financial entities that it may be desired to have on-site include, but are not limited to: computer hardware and software vendors; office supplies vendors; photocopying and printing services; personnel agencies and services; out-sourced business services such as bookkeeping, accounting and payroll services; accounting firms; law offices; offices of commercial dispute arbitration boards and agencies; an office of a local, regional, or national/federal small business assistance organization, such as the Federal Government's Small Business Administration (SBA) in the US; personnel agencies, including temporary and secretarial staff providers; and courier and messenger services. Information about such entities can also readily be ascertained from local and regional chambers of commerce. Where the entities are themselves chains that are regional or national in nature, the NBN organizer may enter into an agreement with such an entity covering more than one branch facility. Where providers are local in nature, the agreement between the NBN and the provider may relate to only one particular branch facility. As participating member institutions appropriate for the type and mission of a particular NBN branch office facility are recruited by the NBN organizer, the specific space requirements of each participant are determined so as to enable the NBN organizer to make a final determination of the size requirements for the given facility.

What is claimed is:

1. A national branch network (NBN) for conducting at least one of financial transactions, financial sales and service activities, and non-financial sales and service activities between a plurality of participating member institutions of the NBN and their customers, which customers are businesses and affluent individuals meeting at least one predetermined qualification, the member institutions including financial and non-financial institutions, with the NBN comprising a plurality of networked shared branch facilities, which are maintained by an NBN maintainer, each shared branch facility being physically located at a different location, such that at each shared facility at least several of the plurality of member institutions maintain a presence, and further such that at at least one shared facility in the network, at least one member institution maintains a financial transaction capability, and wherein the NBN maintainer maintains at least one channel of communication with all of the branch facilities in the network, and individual member institutions maintain at least one channel of communication with those NBN branch facilities at which they maintain a presence and with other member facilities that are not part of the NBN; and such that where there is financial transaction capability at an NBN branch facility, financial transactions between member institutions and their customers are performed by staff of the NBN facility, which are representatives of the NBN maintainer, acting on behalf of the member institutions, with the financial transactions being performed in a common area of the facility; and further such that where there at least one of financial and non-financial sales and service activity conducted at an NBN facility between financial and/or non-financial member institutions and their customers, such financial and/or non-financial sales and service activities are conducted between the respective member institution and its customers from a space within the NBN facility that is utilized exclusively by that member institution.

2. The NBN according to claim 1, wherein the NBN maintainer is a third-party different from all of the member institutions.

3. The NBN according to claim 1, wherein the NBN maintainer is also one of the member institutions.

4. The NBN according to claim 1, wherein the presence of a member institution at a branch facility is selected from the group consisting of: physical, virtual, and a combination thereof.

5. The NBN according to claim 1, wherein there are from about 30 to about 300 networked branch facilities.

6. The NBN according to claim 1, wherein each branch facility is located in a different business district.

7. The NBN according to claim 1, wherein a plurality of branch facilities are located in a business district.

8. The NBN according to claim 1, wherein each branch facility is located in a different city.

9. The NBN according to claim 1, wherein a plurality of branch facilities are located in a city.

10. The NBN according to claim 1, wherein each branch facility is located in a different standard metropolitan statistical area (SMSA).

11. The NBN according to claim 1, wherein a plurality of branch facilities are located in a SMSA.

12. A national branch network (NBN) system branch office facility, forming part of the network of branch facilities according to claim 1, the branch office facility comprising:
a physical location having:
a.) an external area, with indicia of the presence at that location of the NBN branch office facility, and leading to an internal area;
b.) an internal area including:
i.) a reception and waiting area for customers and visitors to the facility, from which customers are subsequently directed to specific other parts of the internal area, at which they can wait until such time as they are directed to proceed to such other parts of the internal area;
ii.) a transaction area in which financial transactions are conducted, the transaction area including at least one member selected from the group of:
A.) at least one automatic teller machine (ATM's);
B.) At least one teller window; and
C.) At least one quick deposit boxes;
iii.) an office area, including at least one and up to a plurality of individual office spaces, each of which is maintained by a participating member institution, in which customers of that member institution engage in financial and non-financial sales and service activities with at least one representative of that member institution, and within which each participating institution maintains at least one channel of communication with other branch offices of that member institution and a main office of that member institution located at a different physical location.

13. The NBN according to claim 12, wherein the at least one channel of communication is a telecommunication line selected from the group consisting of voice, video, computer, and combinations thereof.

14. The NBN according to claim 12, wherein the office area is a space that is itself shared by a plurality of member institutions, at which those member institutions utilize a shared virtual sales and service capability through which they each service their respective customers at different times.

15. The NBN according to claim 12, wherein the NBN is operated and managed by a third-party that is not one of the member institutions.

16. The NBN according to claim 12, wherein the NBN branch facilities are owned or leased by a third-party that operates and manages the NBN, and that is not one of the member institutions.

17. The NBN according to claim 15, wherein at least one of the NBN branch facilities are owned or leased by one of the member institutions.

18. The NBN according to claim 12, wherein at least one of the NBN branch facilities is owned by the third-party that operates and manages the NBN and this is not a member institution, and wherein at least one of the NBN branch facilities is owned by at least one of the member institutions.

19. A method of conducting a national branch network (NBN) system comprising:
a) providing a plurality of branch facilities operated and managed by an NBN operating/managing entity, wherein each facility including a common area, wherein certain general activities are performed; and a plurality of other areas occupied by financial and/or non-financial member institutions of the NBN, wherein certain non-financial activities specific to each financial and/or non-financial member institution are performed;
b) enabling up to a plurality of customers, which are businesses and individuals meeting predetermined qualifications, of the financial and non-financial institutions, to access the common area to perform certain financial transactions and to arrange to access at least one of the other areas occupied by the member financial and/or non-financial institutions to perform certain non-financial activities specific to that financial and/or non-financial member institution.

20. The method according to claim 19, wherein the general activities conducted in the common area includes at least one activity selected from the group consisting of:
conducting financial transactions; scheduling appointments to meet with representatives of the member institutions; and providing information.

21. The method according to claim 20, wherein the financial transactions are engaged in between member financial institutions and their customers.

22. The method according to claim 20, wherein the financial transactions are handled by a representative of the NBN operating/managing entity from a location selected from a teller facility and desk in the common area of the branch facility.

23. The method according to claim 20, wherein the financial transactions include accepting deposits from customers for the member institutions.

24. The method according to claim 23, wherein the deposits are non-cash only deposits.

25. The method according to claim 23, wherein the deposits include both cash and non-cash deposits.

26. The method according to claim 22, wherein when the location at which financial transactions are conducted is a teller facility, the financial transactions further include making cash disbursements to customers of the member institutions.

27. The method according to claim 21, wherein the financial transactions are handled by an automatic teller machine (ATM).

28. The method according to claim 21, wherein the financial transactions are handled by a combination of one of a representative of the NBN at a teller facility or main desk and up to a plurality of automatic teller machines (ATM's).

29. The method according to claim 20, wherein the activity of providing information includes at least one of the following:
providing information pertaining to starting and operating a business in the political
jurisdiction in which the network branch financial institution is located;
providing information pertaining to the activities of stock markets; and
providing information pertaining to currency exchange.

30. The NBN according to claim 1, wherein member financial institutions include at least one institution selected from the group consisting of: commercial banks, investment banks, brokerage houses, and insurance companies.

31. The NBN according to claim 12, wherein the member non-financial institutions include at least one institution selected from the group consisting of: computer hardware and software stores; business supply stores; accounting firms; law firms; printing and duplicating businesses; courier services; telecommunications products and services suppliers; travel services; small business administration offices; and government offices.

32. The NBN according to claim 12, wherein a branch location is provided in a location that is a geographic territory defined according to a parameter selected from the group consisting of: a local political entity; a business district; and a population center.

33. The NBN according to claim 12, wherein the geographic territory is a political entity selected from the group consisting of: a town; a village; and a city.

34. The NBN according to claim 12, wherein the geographic territory is a business district that selected from the group consisting of: a formal business district and an informal business district.

35. The NBN according to claim 12, wherein the geographic territory is a population center selected from the group consisting of: a geographic region having a total population over a predetermined amount; a standard metropolitan statistical area (SMSA).

36. A method for providing financial services to business customers and affluent individual customers, comprising:
providing a financial services facility including:
a.) a common area staffed by employees of the third-party, at which at least one of general business transactions not specific to any financial institution are transacted; information is dispensed to business customers; cash is obtained by business customers; and non-cash deposits to specific financial institutions are received from business customers; and
b.) providing a plurality of financial transaction areas occupied by and staffed by representatives of particular financial institutions, at which financial transactions between business customers and each particular financial institution occur.

37. The method according to claim 36, wherein the financial institutions include at least one institution selected from the group consisting of: commercial banks; investment banks; brokerage houses; and insurance companies.

38. The method according to claim 36, wherein non-cash deposits to specific financial institutions that are received from business customers are further processed by the operator of the NBN by performing one of the operations selected from the group consisting of: accepting non-cash deposits for forwarding to the specific financial institution for which they are intended; forwarding all non-cash deposits to a central check clearinghouse for routine banking system processing; and utilizing a alternative method approved by an appropriate banking regulatory body.

39. A branch office facility of a national branch network (NBN), for providing access to a plurality of financial institutions that are participating members of the NBN, by customers of the participating member financial institutions, the facility comprising:
a.) a common reception and waiting area interior to the facility with a doorway in communication with an exterior of the facility through which persons enter and exit the facility, the reception and waiting area further including: (i) a main reception desk staffed by an NBN representative for making appointments for customers of the participating member financial institutions, for directing customers to an office space of the appropriate participating member financial institution as customers arrive for appointments, and for providing general information about the facility and its participating member financial institutions to customers, prospective customers and visitors to the facility; and (ii) seating for customers and visitors;
b.) at least one of: (i) a teller station, staffed by at least one NBN representative, that is accessible from the common reception and waiting area by customers of the participating member financial institutions for receiving deposits to the participating member financial institutions from the customers; (ii) at least one automatic teller machine (ATM) at which customers can engage in financial transactions; and (iii) a quick deposit box; and
c.) a plurality of financial office spaces, corresponding in number to the number of participating member financial institutions maintaining a presence at that NBN branch office facility, the plurality of financial office spaces being situated in a portion of the NBN branch office facility that is accessible only by passing the main desk and not directly from the exterior of the facility, such that each financial office space is occupied and staffed by one of the participating member financial institutions, at which customers of each respective participating member financial institution engage in activities with representatives of that financial institution.

40. The NBN branch office facility according to claim 39, wherein there is a teller station.

41. The NBN branch office facility according to claim 40, wherein the teller station accepts deposits from customers.

42. The NBN branch office facility according to claim 41, wherein the deposits are non-cash deposits only.

43. The NBN branch office facility according to claim 41, wherein the deposits include both cash and non-cash deposits.

44. The NBN branch office facility according to claim 40, wherein the teller station also dispenses cash to customers.

45. The NBN branch office facility according to claim 39, wherein the participating member financial institutions are selected from the group consisting of: commercial banks, investment banks, insurance companies, mortgage brokers, securities dealers, and combinations thereof.

46. The NBN branch office facility according to claim 45, wherein the participating member financial institutions include at least one commercial bank.

47. The NBN branch office facility according to claim 39, wherein the customers are restricted to business entities and affluent individuals meeting predetermined criteria.

48. The NBN branch office facility according to claim 47, wherein the predetermined criteria are established by at least one of an NBN facility organizer and the participating member financial institutions.

49. The NBN branch office facility according to claim 39, wherein there is at least one ATM.

50. The NBN branch office facility according to claim 49, wherein there is a plurality of ATM's.

51. The NBN branch office facility according to claim 39, wherein there is a teller station and at least one ATM.

52. The NBN branch office facility according to claim 49, wherein the ATM accepts cash and non-cash deposits from customers and dispenses cash to customers.

53. The NBN branch office facility according to claim 39, wherein the main desk also accepts non-cash deposits to participating member financial institutions from customers.

54. The NBN branch office facility according to claim 39, wherein the main desk accepts non-cash deposits to participating member financial institutions from customers only when there is no teller station present at that NBN branch facility.

55. The NBN branch office facility according to claim 39, wherein the activities engaged in between customers of the participating member financial institutions and representatives of the participating member financial institutions include: banking activities; insurance-related activities; mortgage-related activities; and securities-related activities.

56. The NBN branch office facility according to claim 55, wherein the banking activities include cash and non-cash deposits and withdrawals.

57. The NBN branch office facility according to claim 55, wherein the insurance-related activities include: applying for new insurance coverage, paying premiums for existing insurance coverage, and settling claims on insurance policies.

58. The NBN branch office facility according to claim 57, wherein the insurance relates to commercial and business properties and their operations.

59. The NBN branch office facility according to claim 55, wherein the mortgage-related activities include applying for and obtaining new first and subsequent mortgages, re-financing of existing mortgages, and making mortgage payments.

60. The NBN branch office facility according to claim 59, wherein the mortgages are mortgages on commercial properties.

61. The NBN branch office facility according to claim 55, wherein the securities-related activities include the buying and selling of stocks and bonds, and the arrangement, approval, floating and sale of initial public (stock) offerings (IPO's).

62. The NBN branch office facility according to claim 55, further for providing access to at least one and up to a plurality of non-financial institutions that are also participating members of the NBN, by customers of the participating member non-financial institutions and participating member financial institutions, the facility further comprising:
d.) at least one and up to a plurality of non-financial spaces, corresponding in number to the number of participating member non-financial institutions maintaining a presence at that NBN branch office facility, the at least one and up to a plurality of non-financial spaces being situated in a portion of the NBN branch office facility that is accessible only by passing the main desk and not directly from the exterior of the facility, such that each non-financial space is occupied and staffed by one of the participating member non-financial institutions, at which customers of each respective participating member non-financial institution engage in activities with representatives of that non-financial institution.

63. The NBN branch office facility according to claim 62, wherein the non-financial spaces include: office spaces, retail selling spaces for tangible and intangible goods and services, and combinations thereof.

64. The NBN branch office facility according to claim 62, wherein the participating member non-financial institutions are selected from the group consisting of: temporary, part-time, and permanent personnel agencies and services; out-sourced accounting and payroll services; law offices; business materials and service suppliers, including office supplies vendors; copying and duplicating services; messenger and courier services; travel agencies and travel service arrangers and providers; computer hardware and software leasing, sales, support, maintenance and repair service stores and providers; telephone and wireless products and services stores and providers; mobile telephone services; offices of commercial dispute arbitration boards and agencies; public, private and/or governmental organizations and institutions; small business administration (SBA) offices; and combinations thereof.

65. The NBN branch office facility according to claim 62, wherein there are from about 2 to about 12 participating member financial institutions that maintain a presence at the NBN branch office facility; and wherein there are from about 2 to about 12 participating member non-financial institutions that maintain a presence at the NBN branch office facility.

66. The NBN branch office facility according to claim 62, wherein the plurality of financial and/or non-financial spaces are a single physical space shared by participating member institutions, from which they provide virtual sales and service capability to their respective customers at different times.

67. The NBN branch office facility according to claim 39 further including at least one additional space, the use of which is shared by an organizer of the NBN and the participating member financial institutions, the additional space being selected from the group consisting of:
e.) a utility room for use by NBN and participating member staff, alternatively for one or more of the functions of:
i) providing a place at which deposits made by customers are readied for further processing, either by forwarding to the designated recipient member institution, or by forwarding to central bank facilities for processing, check clearing;
ii) as a break room for use by the both employees of the NBN and the member institutions; and
iii) as a place for extra storage of supplies for use by staff of both the NBN and the member institutions;
f.) a conference room, for alternatively conducting one or more of: meetings between customers and representatives of the participating members; internal meetings and training sessions conducted by one of the participating members for its staff; and meetings between the NBN organizer and its staff and one or more of the participating members and their staff;
g.) a storage room for storing one or more of files, supplies and a combination thereof belonging to one or more of the NBN organizer and the participating members at that NBN branch office location; and
h.) a library/research room, wherein participating member institutions and customers have access to business and financial news and information.

68. A national branch network (NBN) system comprising a plurality of networked NBN branch office facilities according to claim 39.

69. The NBN system according to claim 68, wherein there are from about 50 to about 300 networked NBN branch office facilities.

70. A national branch network (NBN) system comprising a plurality of networked NBN branch office facilities according to claim 62.

71. The NBN system according to claim 70, wherein there are from about 50 to about 300 networked NBN branch office facilities.

72. The NBN system according to claim 69, wherein the individual branch office facilities that constitute the network are in different locations.

73. The NBN system according to claim 72, wherein the different locations include different ones of at least one type of geo-political or commercial entity selected from the group consisting of: towns, cities, states, business districts, standard metropolitan statistical areas (SMSA's), regions, and countries.

74. The NBN system according to claim 71, wherein the individual branch office facilities that constitute the network are in different locations.

75. The NBN system according to claim 74, wherein the different locations include different ones of at least one type of geo-political or commercial entity selected from the group consisting of: towns, cities, states, business districts, standard metropolitan statistical areas (SMSA's), regions, and countries.

76. The NBN system according to claim 68, which is at least one of: owned, organized, and managed by a third-party entity that is itself not one of the participating member institutions of the network system.

77. The NBN system according to claim 70, which is at least one of: owned, organized, and managed, by a third-party entity that is itself not one of the participating member institutions of the network system.

78. A national branch network (NBN) system comprising a plurality of networked branch office facilities of a type selected from the group consisting of: full-service financial and non-financial facilities; financial transaction and sales and services-only facilities; non-financial sales and services-only facilities; and combinations thereof, wherein a plurality of participating member institutions, of a nature and character appropriate for the type of facility that each facility is, share space at those facilities where they maintain a presence, and further such that financial transaction and sales and service capabilities are present in at least one branch office facility within the system.

79. The NBN system according to claim 78, wherein participating member institutions present at each such facility are also further at least communicatively networked to other dedicated facilities of that member, which other facilities are not NBN branch office facilities.

80. The NBN system according to claim 79, wherein the participating member institutions have a presence at each such facility that is selected from the group consisting of: physical, virtual; and combinations thereof.
